(19) United States
(12) Patent Application Publication
(10) Pub. No.: US 2003/0078834 A1
(43) Pub. Date: Apr. 24, 2003

(54) Equal time ballot rotation

(76) Inventor: Neil McClure, Longmont, CO (US)

Correspondence Address: Dan Cleveland, Jr., Esq., LATHROP & GAGE L.C., 4845 Pearl East Circle, Suite 300, Boulder, CO, 80301, US

(21) Appl. No.: 10/074,839

(22) Filed: Oct. 24, 2001

(51) Int. Cl. G06F 17/60

(52) U.S. Cl. 705/12

(57) ABSTRACT

An electronic voting system includes a ballot rotation engine for use in changing the order of candidates that are presented to voters through electronically configurable ballot information presentation devices, such as visual displays and audio speakers. The ballot rotation engine may operate according to any schema for changing the selected order, for example, including randomization, uprotation between sequential ballot, downrotation, or a lookup table. The rotation schema may be implemented at a precinct level or throughout an entire election jurisdiction.

### BACKGROUND OF THE INVENTION

Statement of the Problem

Electronic voting systems, such as those shown in U.S. Pat. No. 6,250,548 to McClure et al., teach the use of mobile memory devices that can be used to transport data to and from the electronic voting systems. In general terms, as implemented in large scale elections, sales of electronic voting systems have largely replaced older voting technologies, such as pen and paper ballots, or mechanical punch card systems. The deficiencies of older punch card systems were widely publicized in the United States presidential election for the year 2000, during which inaccuracies derived from punch card systems in the State of Florida created a storm of controversy that spawned complex litigation and threatened for a time to create a constitutional crisis.

The '548 patent to McClure et al. provides an especially significant advance in the art by teaching the use of a mobile memory unit that can be used to transport multiple electronic ballot formats to an election precinct. The ballot formats are reproduced on electronic displays, such as CRT's or LCD's, for presentation to voters during an election. The ballot formats differ in respect to one another according to voter eligibility for participation in various elections. Even so, the ballot formats replicate paper ballots.

Current technologies for producing electronic ballot formats are primarily concerned with replicating formats that would appear on paper ballots. There is no present capability for altering the electronic ballot formats, except to supply different copies of ballot forms according to voter eligibility to participate in different elections pursuant to McClure et al. U.S. Pat. No. 6,250,548.

Elections are a fundamental process through which democracies decide whether to adopt new laws and what persons will occupy an elective office. A variety of studies show that candidates for elective office may sometimes gain an unfair advantage by virtue of their position on the ballot relative to other candidates in a given race. For example, a candidate who's name consistently occupies the first position on the ballot may gain as much as five percent of the vote because of the first name position. This circumstance ostensibly occurs because many undecided voters tend to vote for the first choice in a given race. In close contests, this advantage may be enough to sway the results of an election. Other studies report that the advantage is statistically less significant, perhaps depending upon how well the candidates have made their case to the voting populace.

Some states have attempted to address the problem of unfair advantage by promulgating legislation or regulation requiring rotation of the order of candidates within a race from ballot style to ballot style, or precinct to precinct, or in some other manner. The term “ballot rotation” is hereby defined as any concept or attempt towards improving fairness in an election by any schema of changing the order of ballot options that are presented to voters in an election. As of December, 2000, a study of election law conducted for all state governments, the District of Columbia and several large municipalities has identified the various methodologies in place for ballot rotation.

The methods described by the various state laws addressing ballot rotation are, with a few exceptions, designed for paper ballots. The logistical and economic limitations imposed by the use of paper ballots result in the perpetuation of unfairness because logistical constraints require that the adopted instrumentalities fall far short of the goal of delivering exposure in an equal positional appearance to all candidates. The following descriptions were derived from state laws as they exist today and the variations are result of different opinions of fairness, balanced with the logistical limitations of paper ballots.

No state election laws were found where the order of the races changed. The order of the races remains constant so that offices always appear in the same sequence from ballot style to ballot style, or from precinct to precinct.

A review of state laws reveals that candidates in a particular race are never randomly ordered. The ordering of the candidates begins with the first ordering, or the primary ballot. Applicable law typically mandates the methodology of ordering candidates for the primary ballot. In the various states, the primary ballot set is established by a variety of methods, including alphabetically, by order of registration or by lot drawing. Where ballot rotation does occur, the rotation of candidates then proceeds by taking the candidate name in the first position and placing it at the bottom of the list, with all other candidate names ‘moving up’. Therefore, all ballot rotation methods embrace the concept of the primary ballot reflecting the original ordering as required by law from which the rotation will start. The rotation method of taking the top name and moving it to the bottom of a race, with all other candidates moving up, is common to all applicable state election law.

For a large election, there may be many races that require rotation. Within each of those races, there can be a varying number of candidates. Each race must have its candidates rotated independent of the other races, according to the number of candidates it contains. An “instance of rotation” is a term defined herein to describe all races where rotation of candidates has occurred with the candidates having been rotated once to a new order. All ballot rotation methods include the process where rotation begins with the primary ballot and subsequent candidate ordering is determined by successive instances of rotation.

Various state laws also describe the concept of political subdivision sequencing, which is the sequence that rotated ballots are assigned throughout the jurisdiction. For example, in a statewide election, political subdivisions may comprise various precincts. The primary ballot, or zeroth instance of rotation, is assigned to the first political sub-division as required by law. From the primary ballot set, races are rotated once to give the first instance of rotation, which is assigned to the next political sub-division as required by law. This continues with the instance of rotation incrementing and being assigned to the next sub-division. The most commonly used political sub-division for rotation is the precinct, but political districts are also used with some regularity across the country. The required sequence of sub-divisions may be the order that precincts are listed in an official election book or are defined by the Secretary of State.

One incongruity of ballot rotation, in all states where ballot rotation occurs, is that rotation is applied on a race-by-race basis so that some races may not be rotated for a particular election. For example, judgeship races in some states require ballot rotation, but school board elections do not. Generally, states that require rotation include, at a minimum, rotation of ballot options for federal and statewide races. Below these levels of contests, requirements begin to vary where rotation can be required to include city council races.

Most states have laws that define some procedure for ensuring an initial ordering of names on a ballot and do not provide for further rotation beyond the zeroth instance or primary ballot. The methods used to ensure this so-called fair ordering are extremely varied from state to state. Some states simply order candidates alphabetically, others determine order by lot, by date of candidate certification, by percentage of vote received in previous elections (for partisan races), and by many other means. All these methods are alike in that the order of presentation of candidates is determined prior to creation of the ballots. The ballots are not changed from ballot style to ballot style or precinct to precinct in states that forbid rotation. The logic in creating the initial ordering on the zeroth instance or primary ballot may be convoluted or even statistically unfair. States for which there is either no candidate rotation or no laws concerning ordering at all comprised 58% of the cast votes in the 1996 presidential election.

Of the states that do require ballot rotation, rotation by precinct is the most prevalent method of ballot rotation. States with election laws requiring Rotation by Precinct comprised about 26.2% of the voting populace in the 1996 presidential election. When ballots are rotated by precinct, all ballots for a particular precinct have a fixed instance of rotation where a single ballot form is used in each precinct. The candidate names all appear in the same position on the precinct ballot. Each precinct has a different, fixed instance of rotation so that the candidates appear in a different order throughout an election jurisdiction that is comprised of multiple precincts, but the order does not change within the individual precincts. For a large election with a varying number of candidates in a multitude of races, it is statistically unlikely that any two instances of rotation will produce ballots with the same ordering of candidates i.e., no two precincts will have the same ballot ordering.

The precinct rotation approach to ballot rotation arises from the logistical practicalities of printing paper ballots. The practice deviates from the intent of ballot rotation because there are significant variances in the number of registered voters in the various precincts. Thus, each candidate is unlikely to appear in the first position for an equal number of voters. This circumstance is clearly a compromise between the idea of equal time for candidates in each position and the limitations that are imposed by having to print and distribute all the different ballots at each precinct.

The various states presently have no system that is capable of providing for ballot rotation where each candidate's name occupies the first position on the ballot an equal number of times. California appears to have carefully considered the problem, and has legislated an extremely complex system of ballot rotation that uses random drawings to create a randomized alphabet. Ballot rotation is done at the precinct level. Precincts are combined into clusters that each receive a single instance of rotation. The clusters are designed to balance the population that receives any one instance of rotation. The number of instances of rotation is determined by a mathematical formula that does not necessarily give each candidate equal exposure at the top of the ballot. Many exceptions to the general rules apply for the different types of races, e.g., municipal versus state or county, and judicial versus congressional races.

Despite efforts to enhance statistical fairness relating to the ordering of candidates, no election jurisdiction has ever implemented a solution overcoming the inherent logistical and economic difficulties that are driven by the need to print paper ballots.

### SOLUTION

An electronic voting system, as described below, provides a ballot rotation engine that overcomes the problems which are outlined above by overcoming the logistical difficulties that are inherent to non-reconfigurable ballots. The ballot rotation engine is capable of implementing a comprehensive ballot rotation schema that meets the requirements of law in any jurisdiction, and it permits implementation of a ballot rotation schema at any level, such as the precinct level, even where ballot rotation has heretofore not been possible.

One implementation of the instrumentalities described herein comprises a memory storage device containing ballot information. The ballot information includes, for example, a plurality of ballot options for a contest. Each ballot option is designated in a selected order of ballot options for the contest to define a primary ballot. A voting station includes an electronically configurable ballot information presentation device, such as a liquid crystal display, cathode ray tube, audio speaker, or Braille printer, that is operable for presenting the ballot information in the selected order during a first voting session. A voter input device, such as a keyboard, joystick, rotary input device, or manually actuatable switch system, permits voter directed ballot data entry to produce a cast ballot responsively to the ballot information that the ballot information presentation device presents to the voter. The ballot rotation engine may, for example, comprise a central processor or other computing device that is configured with program instructions that are operable to change the selected order of ballot options according to a predetermined ordering schema for additional voting sessions. Thus, for example, successive voters at the same voting station may be presented with different iterations of selected ordering of candidates, i.e., different instances of rotation.

New technologies that produce electronic ballot formats, especially the eSlate™ system provided by Hart InterCivic of Austin, Tex., are capable of providing primary ballots according to conventional requirements in various jurisdictions. The electronic format of these ballots may, for example, be comprised of fields including voter options that are related to a particular race, such as a list of candidate names in a presidential election. It has now been determined that this primary ballot structure may serve as a basis or template for generating multiple rotated ballots by rotating the fields to change the order of ballot choices in races that are presented to voters, for example, at different times as different voters are voting at a particular voting station.

While a single voting station may be configured with a ballot rotation engine, it is preferably contemplated that the electronic voting system comprises a network including a precinct control unit and a plurality of voting stations. In this case, the electronic voting system is preferably but optionally configured to assess the memory storage device to obtain the ballot information and process the same to implement the ordering schema among the plurality of voting stations. By way of example, the precinct control unit may substantially balance the selected order of ballot options amongst the plurality of voting stations so as not to favor any one of the plurality of ballot options at a precinct level during the course of an election. Where, as is preferred, the ballot information includes a plurality of contests each identified with corresponding ballot options, the ballot rotation engine may be programmed to change the selected order of corresponding ballot options within the plurality of contests or selected contests. Program instructions are optionally provided for implementing a variety of different ordering schema, which may be used to order contests differently according to the requirements of law within an election jurisdiction or an election precinct. These requirements may differ, for example, between races for elective officials and referendum contests relating to proposed new legislation.

The ballot rotation engine may operate on a variety of different principles according to any conceivable ballot rotation schema or plan. For example, the plan may comprise a complete randomization of the selected order of ballot options between successive iterations based upon an initial primary ballot. Alternatively, the ballot options may be assigned an initial order by conventional methodology in the creation of a primary ballot and subjected to uprotation or downrotation of adjacent options, however, this type of rotation differs from conventional methods in that the rotation occurs on demand at the level of an individual voting station, a voting precinct, a group of precincts supported at a polling place, or an entire election jurisdiction. The electronic voting system may even be statistically programmed to compensate for other precincts where paper ballots are in use by adjusting the selected orderings to eliminate a number of selected orderings corresponding to the number of votes that are cast on the paper ballots where the ordering is known. The overall purpose of the ballot rotation schema is to improve election fairness by providing a number of rotation instances for each candidate at the top of the selected order, or even at any level of ordering, such that predominance of any one candidate at the top of the selected order is statistically insignificant in influencing an election outcome. This may even be implemented through use of a lookup table that provides, for example, a statutory implementation of an ordering schema or a series of order permutations.

The electronic voting system, according to other instrumentalities, operates according to a method of electronic voting. The method steps include providing the electronic voting system with ballot information including a plurality of ballot options for a contest, designating each ballot option in a selected order of ballot options for the contest, presenting to a voter the ballot information for the contest in the selected order of ballot options during a first voting session, permitting the voter to produce a cast ballot responsively to the ballot information, and iterating to change the selected order of ballot options according to a predetermined ordering schema for additional voting sessions that are allocated to subsequent voters. Variations of the methodology exist according to the various options that are discussed above in reference to the electronic voting system.

### OBJECTS OF THE INVENTION

Accordingly, it is an object of the invention, according to various instrumentalities, that an electronic voting system and associated methodology be equipped with an electronically reconfigurable ballot rotation capability.

It is a further object of the invention that the electronic voting system and associated methodology, according to their preferred embodiments, enhance the fundamental fairness of election processes by providing for ballot rotation at different levels, such as the ballot, precinct or election jurisdiction level, where equally fair ballot rotation has heretofore been impracticable.

### BRIEF DESCRIPTION OF THE DRAWINGS

FIG. 1 is a block diagram showing the various components of an electronic voting system that implements a ballot rotation schema at a plurality of levels including the level of an entire election jurisdiction, a precinct level, and a local voting station level;

FIG. 2 is a schematic block diagram showing the implementation of a ballot rotation engine at a precinct level;

FIG. 3 depicts a contest in a primary order of ballot options;

FIG. 4 depicts the primary ballot of FIG. 3 in an instance of uprotation;

FIG. 5 depicts the primary ballot of FIG. 3 in an instance of downrotation;

FIG. 6 depicts the primary ballot of FIG. 3 in an instance of randomized rotation;

FIG. 7 depicts a lookup table for use in computing various instances of ballot rotation;

FIG. 8 is a process schematic demonstrating program logic for a ballot rotation engine; and

FIG. 9 is a second embodiment of a voting system having various modifications in comparison to the system shown in FIG. 1.

### DETAILED DESCRIPTION OF THE PREFERRED EMBODIMENTS

The following detailed description is intended to teach concepts of the invention by way of preferred example and not by limitation. There will now be shown an example of an electronic voting system that operates at many different levels where the concepts of the invention may be implemented at any level.

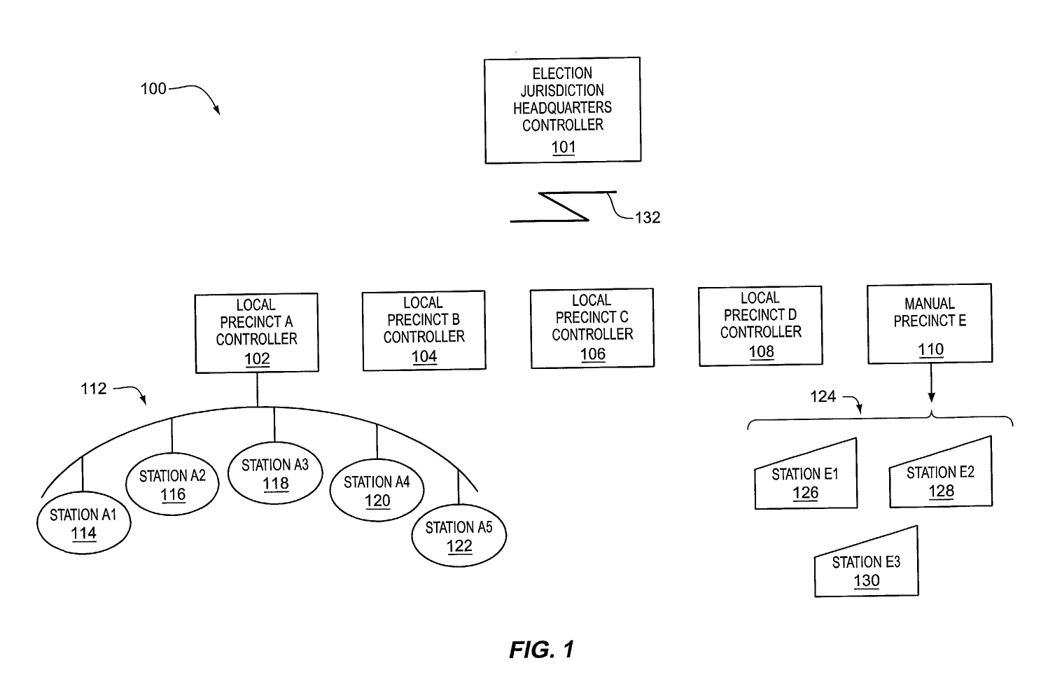

FIG. 1 is a block schematic diagram of an electronic voting system 100. The system 100 includes an election jurisdiction headquarters controller 101, which governs overall operation of the system 100. The election jurisdiction headquarters controller 101 may, for example, be a personal computer, a telecommunications server, or any similar device, that sends and receives any information which is useful during the course of an election. For example, this information may include ballot information, as well as information for accumulating totals of votes for various contests among the respective precincts. There is preferably only one election jurisdiction headquarters controller 101, however, for a variety of reasons including, for example, speed of processing, geography, and redundancy in case of failure, the functions of the election jurisdiction headquarters controller 101 may be shared or distributed among a plurality of such controllers.

The geographical extent of an election jurisdiction may comprise, by way of example, a national, statewide, state political subunit (e.g., county or parish), municipal, or municipal district jurisdiction. Election jurisdictions are typically divided into precincts that each report to an election jurisdiction headquarters. As used herein, the term “precinct” is used to denote the smallest political subdivision used to define voter eligibility for various contests. A polling place, such as a school or government building, where people may vote can include one or more precincts. Polling place can be used interchangeably with references to precinct herein and represents multiple precincts in a single polling place. From state to state and depending upon the nature of the election, the terminology in use, such as cluster or polling place, may differ from that of “precinct,” but all such locations indicate political subdivisions and fall within the meaning of “precinct” as used herein. As shown in FIG. 1, there are five such precincts. Four have local controllers, which are respectively numbered 102, 104, 106, and 108. Voting at a fifth precinct 110 is performed manually. The five precincts shown in FIG. 1 can also represent five polling places, where each polling place supports multiple precincts at a single geographical location.

There may be any number of precincts, and the system in place at any one precinct may vary with respect to any other precinct. For example, a network system 112 is in use in connection with the local precinct controller 102, such that a plurality of electronic voting stations 114, 116, 118, 120, and 122 are connected with the local precinct controller 102. The program functionality of the local precinct controller 102 is duplicated at each of the electronic voting stations 114-122, and the election may continue at the other precincts even if the local precinct controller 102 fails during an election. Alternatively, the election jurisdiction headquarters controller 101 may be programmed to substitute for the local precinct controller 102 in the event of such failure. Thus, program functionality including the aforementioned ballot rotation engine is optionally but preferably redundant in at least three levels including the election jurisdiction headquarters controller, the local precinct controller 102, and the individual voting stations 114-122.

The fifth precinct 110 contains a plurality of manual voting booths 126, 128, and 130 having conventional paper ballots. The system in place at precinct 110 may be one based upon manual counting of votes from the paper ballots, optical scanning of votes from the paper ballots, punch-card systems, or older electronic systems that positionally interface with a paper ballot. The paper ballots in use at precinct 110, according to conventional paper ballot practices, may be identical with respect to one another, and ballot rotation at the ballot level is impossible due to the use of paper ballots. However, a manual count of voters is maintained and periodically provided to the election jurisdiction headquarters controller 101, which is able to adjust the remainder of system 100 to accommodate for the deficiency or lack of ballot rotation in precinct 100.

The voting system 100 operates to provide ballot rotation according to any schema that provides substantially equal exposure for each candidate in the first ballot position. For example, Table 1 below documents one-hundred instances of rotation for each candidate where the bottom candidate is rotated to the top of the order in each instance.

TABLE 1
FIRST POSITON IN 100 INSTANCES OF ROTATION

| Race | Candidate | First Position Instances |
|---|---|---|
| 1 | A | 50 |
| | B | 50 |
| | Total Race 1 | 100 |
| 2 | C | 34 |
| | D | 33 |
| | E | 33 |
| | Total Race 2 | 100 |
| 3 | F | 25 |
| | G | 25 |
| | H | 25 |
| | K | 25 |
| | Total Race 3 | 100 |

As shown in FIG. 1, an optional telecommunications linkage 132 can be used to connect the local precinct controllers 102-108, and even precinct 110, with the election jurisdiction headquarters controller 101. The telecommunications connection 132 is not essential for the performance of voting system 100, but may be used for troubleshooting operations, implement software fixes, permit the election jurisdiction headquarters controller 101 to monitor election results in progress from the local precinct controllers 102-110. The telecommunications linkage 132 may also be used to or account for the turnout in the precinct allocated to precinct controller 110, where ballot rotation is not possible, and adjust the rotation in other precincts to compensate for such turnout by leveling the candidate rotation distribution amongst all of the precincts.

As shown in FIG. 1, independent rotation by each of the local precinct controllers 102-108, as shown in Table 1, results in no one candidate having a statistically significant advantage. For example, 500 votes might be cast in a race having four candidates, and the name of one candidate out of four candidates could occupy the first position one more time than the names of the other three. In this circumstance, the statistical advantage in terms of actual votes cast for the one candidate having this advantage would be approximately 1/125×0.05 or 4×10⁻⁴ votes.

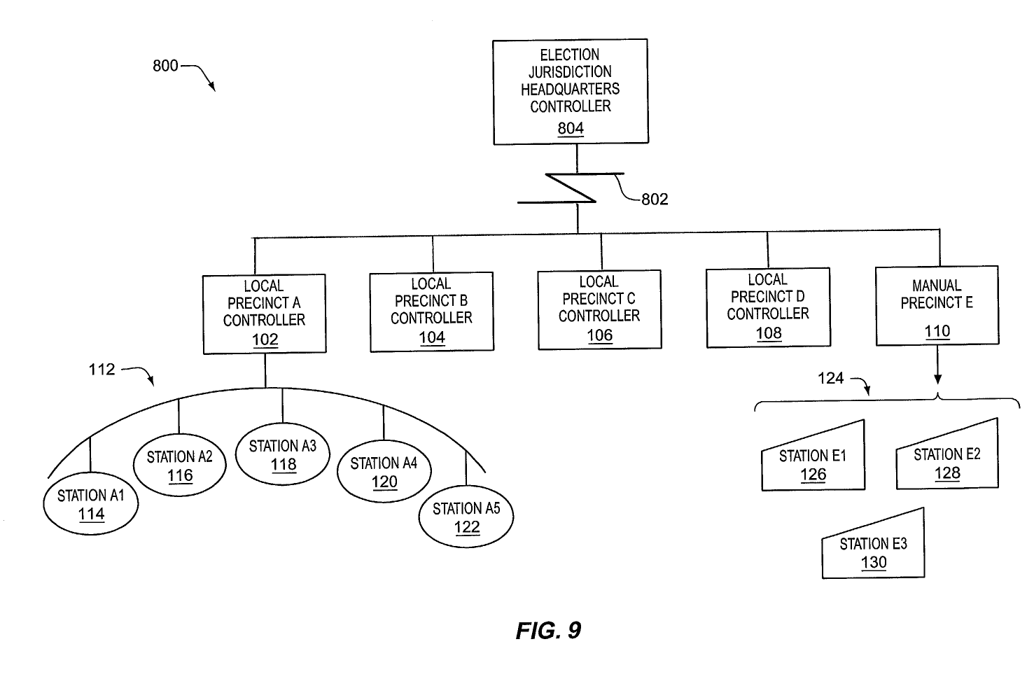

In FIG. 9, like numbering of identical items has been retained with respect to FIG. 1, FIG. 9 depicts a second voting system 800 in which a system of lines 802 connected the respective local precinct controllers 102-106 and precinct 110 with the election headquarters controller 804. This system of lines 802 is preferably a telecommunications connection 132, such as a dedicated telecommunications line or encrypted Internet pathway. In this manner, the election jurisdiction headquarters 804 is able to accumulate voting instances of non-rotatable ballots in precinct 110 and compensate for this load by adjusting rotation instances in other precincts.

By way of example, a periodic report from precinct 110 to the election jurisdiction headquarters controller 804 may indicate that fifty voters have cast paper ballots in Precinct 110 corresponding to an order A-B of candidates in Race 1. Some of these races will be exclusive to precinct 110, and other races will be shared by other precincts. As to the shared races where, for example, results for Race 1 shown in Table 1 are being accumulated by all precincts, the election jurisdiction headquarters controller 804 may then send control signals to each of the local precinct controllers 102-106, such that the instance of rotation presiding on paper ballots in precinct 110 is, in combination, not presented to voters for a sufficient number of times to compensate for the fixed instance of rotation that presides in Precinct 110. Thus, where local precinct controllers 102-106 and precinct 110 all participate in Race 1, future rotation instances in precincts 102-106 following the report from precinct 110 may be adjusted according to Equation (1)

S=(C×F)/P (1);

where S is the total number of ballot rotation instances during which first position presentation of a candidates name must be skipped by a local precinct controller; C is the number of candidates in a particular race; F is the number of nonrotated cast ballots that require compensation, and P is the number of precincts that will participate in compensating the nonrotated ballots.

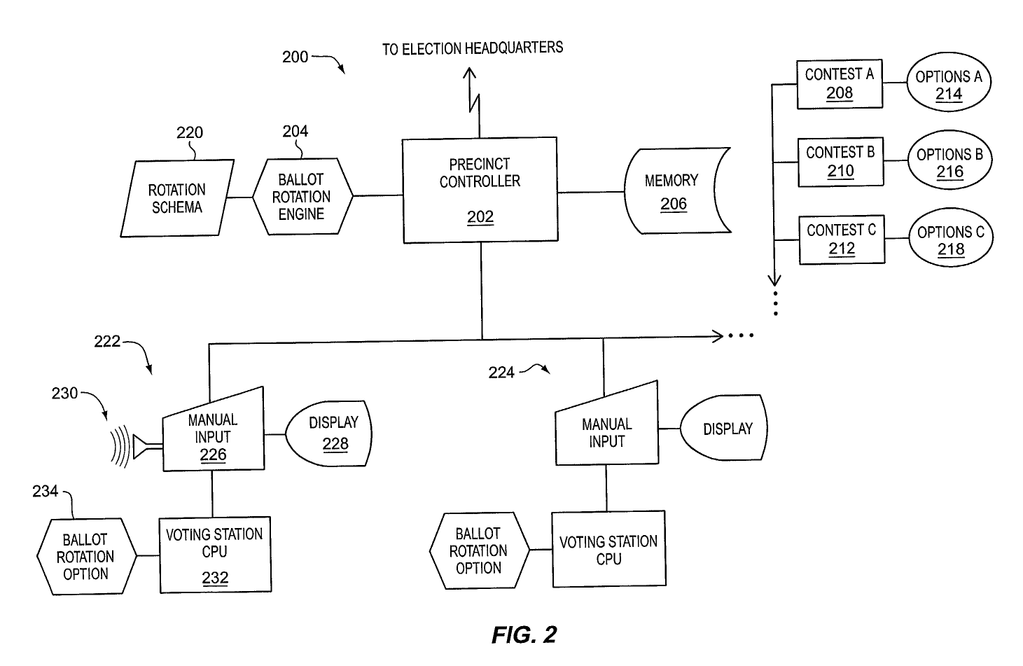

In some circumstances, polling may occur at a location that has no telephone connection nor any other mechanism to provide lines 802. For example, FIG. 2 shows local precinct controller 108 disconnected from lines 802. In this circumstance, the local precinct controller 200, which functions as a standalone rotation system, as in the mode of precinct controllers 102-108 shown in FIG. 1.

According to additional instrumentalities of the electronic voting system, there will now be shown an electronic voting system that uses a ballot rotation engine to operate upon ballot information that is accessed from a memory storage device. FIG. 2 is provided for this purpose, and shows additional detail with respect to an optional but preferable precinct level implementation 200 of the electronic voting system, which may be implemented together with or as part of any one of the local precinct controllers 102-108 shown in FIG. 1.

The precinct level implementation 200 comprises a precinct controller 202, which is configured by program instructions and data to perform any of the conventional functions of a local precinct controller. By way of example, an implementation of a precinct controller may comprise a personal computer or other processor that is provided with program instructions for execution of these conventional functions. A particularly preferred form of precinct controller 202 is the Judge's Booth Controller or JBC 1000, which is specially made for use as a precinct controller and is commercially available from Hart InterCivic of Austin, Tex. The JBC 1000 can be programmed with ballot rotation software instructions, and the concept has been proven in a pilot program.

In addition to conventional functionality, the precinct controller 202 is programmed with instructions that provide for a ballot rotation engine 204. The ballot rotation engine 204 accesses a memory storage device 206 to obtain ballot information that is stored therein. The memory storage device 206 may, for example, be random access memory, flash memory or EEPROM, an optical disk, a magnetic disk or drum, a tape drive, volatile or nonvolatile memory, or any other form of data storage device. The memory storage device 206 is optionally but preferably created at a central location, such as the election jurisdiction headquarters or commercial processing facility, and distributed to the respective precincts. Commercial processing for this purpose may be obtained, for example, from Hart InterCivic of Austin, Tex. Alternatively, the ballot information may be provided to the precinct controller and memory storage device 206 by secure electronic transmission from the election headquarters or the commercial processing facility.

Due to the fact that different ballot styles may be required for each precinct and even within a single precinct, it is particularly preferred that each of the memory storage devices contain a copy of all of the ballot styles that will be used within the jurisdiction on a given election day. For example, all voters in a state are entitled to vote for the state governor, but only a few residents in a given city may be entitled to vote on a particular bond issue. The need for different ballot styles exists because each voter should be presented with ballots formed of only those contests in which the voter is entitled to vote. This multiplicity of ballot styles on a single memory storage device greatly simplifies the logistics.

The ballot information includes, for example, a plurality of ballot options for a contest. Each ballot option is designated in a selected order of ballot options for the contest. As show in FIG. 2, the ballot information includes a listing or data structure containing a plurality of contests 208, 210, and 212 where each contest is associated with options or ballot choices such as options 214, 216, and 218. Each of the options 214-218 can include a further subset or subsets of options. By way of example, contest 208 may be a presidential race that is associated with a set of options 214 including a list of seven presidential candidates. Contest 210 may be a municipal bond issue that only certain residents of the precinct are eligible to vote for, such as yes/no options 216 whether a municipal water district should obtain bond financing to renovate a sewer on a particular street within the district and tax residents of the district accordingly. Contest 212 may be a referendum for new legislation, for example, comprising yes/no options 218 to amend the state constitution.

The ballot rotation engine 204 is programmed with at least one ballot rotation schema 220, which may be provided as program instructions that operate on the ballot information 208-218, or packaged as an object including executable rules that are also provided on the memory storage device 206. These program instructions comprise any plan for enhancing election fairness by the selective ordering of candidates in different voting instances.

The precinct controller 202 is networked to a plurality of electronic voting stations, such as stations 222 and 224. As in the case of station 222, these stations each preferably include a manual input device 226 and associated visual display 228. Examples of manual input devices include, but are not limited to, keyboards, rotary input devices, joysticks, and manual switches, as well as disabled access input devices such as breath switches, head switches, foot pedals and the like. Examples of visual displays include liquid crystal displays, cathode ray tubes, image projection systems, and flat panel displays. An audio speaker system 230, such as headphones, an earplug or broadcast speaker, may be used to facilitate voting efforts of visually impaired persons. Collectively, the visual display 228, the audio speaker system 230, and any other device that may be used to deliver election data to a voter, such as a Braille printer, are referred to herein as electronically configurable ballot information presentation devices. Each voting station is optionally but preferably provided with its own programmably configurable processor 232, which may also be provided with program instructions to implement a ballot rotation option 234 at the level of the voting stations, as opposed to the precinct controller 202. An example of a commercially available device for use as the voting station 222 is the eSlate™ system with optional disabled access units, which are available from Hart InterCivic of Austin, Tex.

It will be appreciated that the functionality of voting stations 222 or 224 may be combined with the functionality of precinct controller 202 such that a single voting station also functions as its own controller. In this case, there may be a plurality of individual controller/voting stations in a single precinct. The individual controllers need not be connected to a plurality of voting stations in the manner shown in FIG. 1 where precinct controller 102 is connected to voting stations 114-122. Each combined controller/voting station may have its own optional telecommunications linkage 132. The memory cartridge 206 and all other structures shown in FIG. 2, as well as associated program logic, may be connected to the combined controller/voting station.

As indicated above, the electronic voting systems according to the various instrumentalities described herein utilize a ballot rotation engine that operates according to a specified schema or plan. The schema may mimic any statutory plan that is now in existence or which comes into existence. A particular advantage of the instrumentalities described herein is the ability to implement the schema at any level, especially at the precinct or polling place level. For example, it is clear that the extant comprehensive California system of ratios, clusters, and exceptions is an attempt to compromise between fundamental fairness and what may be practically implemented in current voting systems. The complexity of this situation may be entirely eliminated with improved fairness, for example, by using electronic means to completely randomize the order of ballot options between voting sessions during the course of an election.

As previously described, a polling place can consist of multiple precincts. Thus, voters from a variety of precincts can vote in the same physical location. In the extreme instance, the practice of Early Voting requires that all precinct ballot styles be available in any given Early Voting polling location. The present invention contemplates this fact by encompassing the ability to rotate candidates by physical location. As an example, voter A from precinct X votes in a presidential election in an Early Voting location where all precincts are available for the jurisdiction. The next voter in the same location to be approved to vote is voter B from precinct Y. While voter B is from a different precinct, he or she is still entitled to vote for president but receives a different ballot because the lower level races differ, i.e. voter B is from a different precinct. However, voter B has the candidates for president rotated one instance according to the rotation schema relative to Voter A. In this application of the present invention, candidate rotation occurs at the race level based on location. This further increases positional fairness by rotating candidates based on the presentation of the race to voter by location, regardless of precinct affiliation.

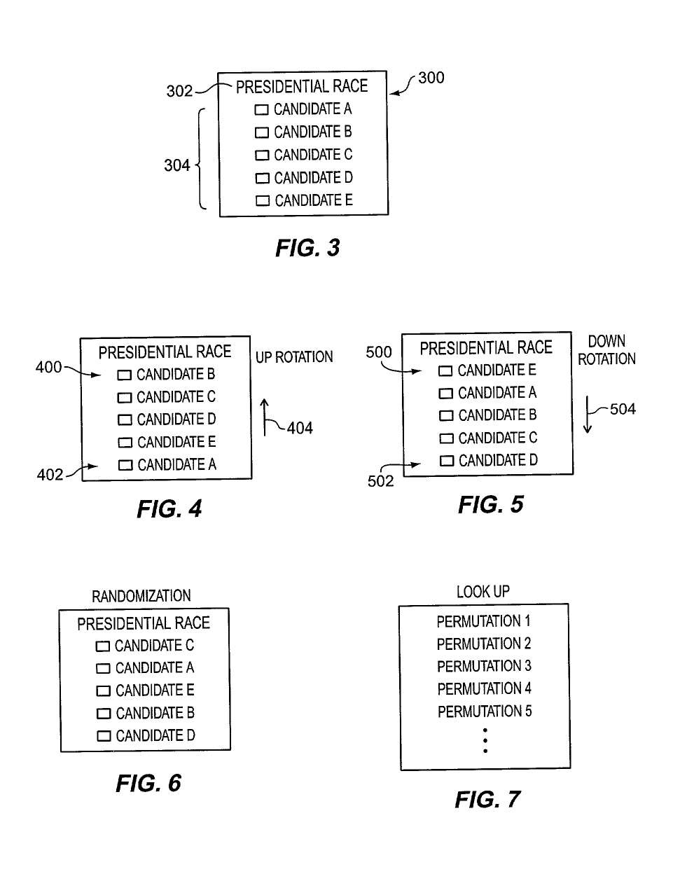

The rotation schema may be implemented at any level of structure shown in FIGS. 1 and 2, along with any other embodiment that satisfies the objective of delivering electronic data to voters. FIGS. 3 through 7 illustrate a variety of schema that may be implemented. FIG. 3 depicts a conventional primary ballot 300, which is produced according to any conventional technique for producing such ballots. Alternatively, the order of candidates may be presented in any order, as special techniques of ballot ordering to produce an official primary ballot are not necessarily required. A contest identifier 302 is for a presidential race, and a plurality of ballot option identifiers 304 represent the ballot options that are identified to the contest. While the visual presentation to the voter may appear as shown in FIG. 3, the ballot information comprising the contest identifier 302 and the ballot option identifiers 304 resides on the memory storage device 206 (see FIG. 2) in the form of a digital data file, which may be organized in the form of a database structure, such as a hierarchical or relational database, a sequential file, a comma delimited file, or any other data structure. The initial order of ballot options shown in FIG. 3 may be rearranged into a different selected order according to a predetermined ordering schema for additional voting sessions. Thus, successive voters at the same voting station may be presented with different iterations of selected ordering of candidates.

The ballot rotation engine may operate on a variety of different principles according to any conceivable ballot rotation schema or plan. For example, as shown in FIG. 4, the plan may comprise an uprotation where the initial ballot option (for Candidate A) is removed from position 400 to the bottom position 402. The remaining ballot options maintain their adjacent order with respect to one another and are shifted upwardly in the direction of arrow 404.

FIG. 5 depicts a downrotation where the last ballot option (for Candidate E) is shifted to a top position 500 from the bottom position 502. The remaining ballot options maintain their adjacent order with respect to one another and are shifted downwardly in the direction of arrow 504.

FIG. 6 depicts the ballot information of FIG. 3 after complete randomization of the selected order of ballot options between successive iterations. In this instance, randomization may occur by any technique, such as generating a quantity of random numbers corresponding to the number of ballot options, assigning the random numbers to ballot options on a one-to-one basis and then rank ordering the random numbers to iterate or assign a new selected order of ballot options. This technique may develop statistical problems in implementation due to the fact that most random number generators do not produce a truly random set of numbers. This problem may be overcome by obtaining the random numbers from a lookup table formed of a substantially random sequence of numbers.

FIG. 7 depicts yet another schema comprising a lookup table formed of all of the respective permutations of order that are possible for the field of candidates. The total number of permutations is equal to the factorial of the number of ballot options for the contest. For example, in a field of five options, there are 5! or one hundred and twenty permutations of order.

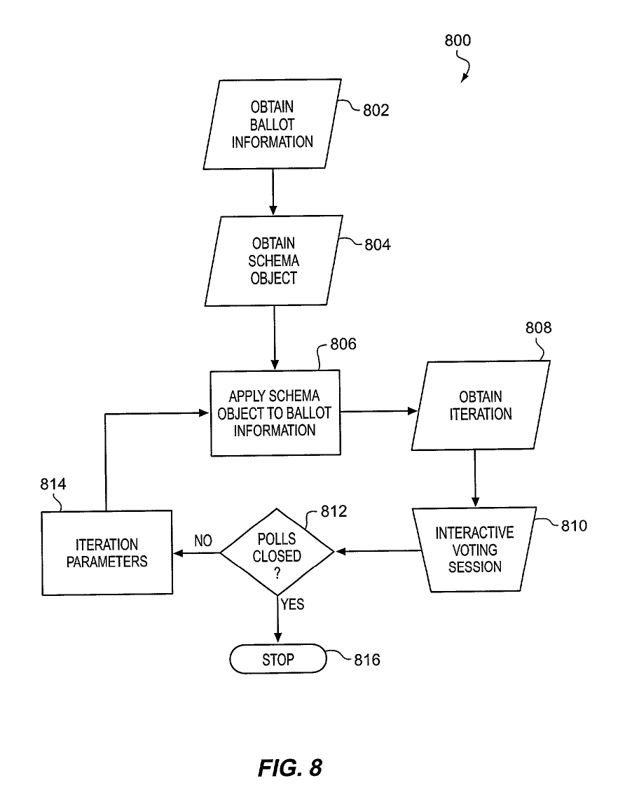

FIG. 8 is a process schematic diagram depicting a method 800 of operation for use in the ballot rotation engine 204 or the ballot rotation option 234 shown in FIG. 2. The method may be implemented by program instructions for any processor. In step 802, the ballot rotation engine existing, for example, as a programmably configured processor and associated memory, obtains the ballot information from memory including contests and associated ballot options. In step 804, the ballot rotation engine obtains the schema object, which contains executable code in combination with data that is required for execution of the code. Alternatively, the code and data may be programmed directly into the ballot rotation engine.

In step 806, the schema object is applied to the ballot information to produce an instance of ballot rotation resulting in a ballot construct in step 808. This ballot construct is presented to a voter during an interactive voting session in step 810, which proceeds in a conventional manner until the voter casts a ballot to conclude the voting session. In step 812, the ballot rotation engine checks to ascertain whether the polls have closed. If not, the object schema is reset or incremented with new iteration parameters, such as the generation of random number sequences for rank ordering, the generation of a new iteration permutation from a lookup table as previously discussed, an uprotation, a downrotation, or any other rotation, such as a rotation in compliance with local law, in step 814. The sequence of ballot rotation proceeds in new iterations through steps 806 to 814 until the polls have closed, in which case voting ceases in step 816.

The process steps 806 through 814 do not necessarily need to proceed with a iteration for each new voter. For example, the interactive voting session in step 810 may proceed through a series or predetermined number of voters, e.g., five voters, or a single voting station on a network may be maintained to present a constant ballot of a first iteration while other voting stations are maintained with a constant ballot of a different iteration. The ballot rotation engine may periodically adjust these constant ballots by making a ballot of a different iteration to provide statistical fairness by, for example, giving equal time rotations to all candidates in a particular field.

In an electronic voting system that is governed by an election jurisdiction headquarters server 101 of the type shown in FIG. 1 or 2, headquarters server 101 may be statistically programmed to compensate for other precincts where paper ballots are in use by adjusting the selected orderings to eliminate a number of selected orderings corresponding to the number of votes that are cast on the paper ballots where the ordering is known. Thus, the local precinct systems, as shown in FIG. 2, would receive signals from the headquarters server 101 and act upon these signals to eliminate a number of ballot rotations corresponding to the selective ordering on paper ballots that are presented to voters who do not vote on systems having electronically reconfigurable ballots. The number of ballots presented to voters in these non-reconfigurable systems would have to be tracked locally as the votes are cast. The counts would need to be provided to either the election jurisdiction headquarters server 101 or the precinct controller 202, in order to provide these systems with an accounting that can be used for statistical compensation to enhance fairness over the entire jurisdiction, even where paper ballots are in use within a few precincts.

Additionally, the basic process steps shown in FIG. 8 may be adapted to substitute contest information for the ballot information in step 802. Thus, the rotation iteration in step 808 may comprise a rotated list of races, as opposed to a rotated list of ballot options for a particular race. The advantage of rotating contests would be to avoid the possible prejudice to a particular contest that might succeed another contest. For example, a ballot initiative to build a new football stadium may be followed by a ballot initiative to increase taxes for school funding. A voter might vote affirmatively to build the new stadium and, upon viewing the school tax initiative, become concerned that taxes will rise too steeply for all of these projects. Thus, the order of voting on particular contests may also influence the outcome of various contests, and it is possible to provide an iterative rotation of selected order in contests to avoid this type of prejudice as well.

Those skilled in the art will appreciate that the instrumentalities which are described above may be subjected to minor modifications without departing from the scope and spirit of the invention. For example, additional process steps may be added to or combined with one another in the method 800 shown in FIG. 8. The ordering of the method steps may also change. Accordingly, the inventors hereby state their intention to rely upon the Doctrine of Equivalents to protect the full scope of their rights.

1. An electronic voting system comprising:
a memory storage device containing
ballot information including a plurality of ballot options for a contest, each ballot option designated in a selected order of ballot options for the contest;
a voting station including
an electronically configurable ballot information presentation device operable for presenting the ballot information in the selected order during a first voting session, and
a voter input device operable for permitting voter directed ballot data entry to produce a cast ballot responsively to the ballot information presented by the ballot information presentation device; and
a ballot rotation engine operable to change the selected order of ballot options according to a predetermined ordering schema for additional voting sessions.

2. The electronic voting system as set forth in claim 1, comprising a network including a precinct control unit and a plurality of voting stations.

3. The electronic voting system as set forth in claim 2, wherein the precinct control unit is configured to access the memory storage device to obtain the ballot information and process the same to implement the ordering schema among the plurality of voting stations.

4. The electronic voting system of claim 3, wherein the ordering schema is implemented through program instructions to the precinct control unit for balancing the selected order of ballot options amongst the plurality of voting stations so as not to favor any one of the plurality of ballot options at a precinct level during the course of an election.

5. The electronic voting system of claim 1, wherein the ballot information includes a plurality of contests each with associated ballot options, and the ballot rotation engine is operable to change the selected order of the associated ballot options among the plurality of contests.

6. The electronic voting system of claim 1, wherein the ballot information includes a plurality of contests with associated ballot options and the ballot rotation engine is operable to change the selected order of corresponding ballot options among selected ones of the plurality of contests.

7. The electronic voting system of claim 6, including a plurality of predetermined ordering schema for use in the ballot rotation engine, each of the contests being identified to a selected one of the plurality of predetermined ordering schema.

8. The electronic voting system as set forth in claim 1, wherein the contest comprises a race for elective officials.

9. The electronic voting system as set forth in claim 1, wherein the contest comprises a referendum for proposed new legislation.

10. The electronic voting system as set forth in claim 1, wherein the electronically configurable ballot information presentation device comprises a visual display.

11. The electronic voting system as set forth in claim 1, wherein the electronically configurable ballot information presentation device comprises an audio speaker.

12. The electronic voting system as set forth in claim 1, wherein the electronically configurable ballot information presentation device comprises a Braille printer.

13. The electronic voting system as set forth in claim 1, wherein the voter input device comprises a manually actuatable switch.

14. The electronic voting system as set forth in claim 1, wherein the voter input device comprises a voter-directed ballot navigation tool.

15. The electronic voting system as set forth in claim 1, wherein the predetermined ordering schema of the ballot rotation engine comprises program instructions for randomization of the selected order of ballot options between successive iterations.

16. The electronic voting system as set forth in claim 1, wherein the predetermined ordering schema of the ballot rotation engine comprises program instructions for sequential rotation of the ballot options.

17. The electronic voting system as set forth in claim 16, wherein the program instructions for sequential rotation of the ballot options comprise program instructions for uprotation of adjacent ballot options.

18. The electronic voting system as set forth in claim 16, wherein the program instructions for sequential rotation of the ballot options comprise program instructions for downrotation of adjacent ballot options.

19. The electronic voting system as set forth in claim 1, wherein the predetermined ordering schema of the ballot rotation engine comprises program instructions for implementing a system of rotation at a precinct level.

20. The electronic voting system as set forth in claim 1, wherein the predetermined ordering schema of the ballot rotation engine comprises program instructions for implementing a system of rotation at an election jurisdiction level.

21. The electronic voting system as set forth in claim 1, wherein the predetermined ordering schema of the ballot rotation engine comprises program instructions for implementing a system of rotation that provides a number of rotation instances for each candidate in a first position of the selected order such that predominance of any one candidate at the top of the selected order is statistically insignificant in influencing an election outcome.

22. The electronic voting system as set forth in claim 1, wherein the predetermined ordering schema of the ballot rotation engine comprises program instructions for implementing a system of rotation that provides, as close as is mathematically possible, an equal number of rotation instances for each candidate at all positions of the selected order.

23. The electronic voting system as set forth in claim 1, wherein the ballot rotation engine comprises program instructions for implementing a lookup table for changing the selected order of the additional voting sessions.

24. A method of electronic voting through use of an electronic voting system having an electronically configurable ballot information device, the method comprising the steps of:
providing the electronic voting system with ballot information including a plurality of ballot options for a contest;
designating each ballot option in a selected order of ballot options for the contest;
presenting to a voter the ballot information for the contest in the selected order of ballot options during a first voting session;
permitting the voter to produce a cast ballot responsively to the ballot information; and
iterating to change the selected order of ballot options according to a predetermined ordering schema for additional voting sessions.

25. The method according to claim 24, wherein the electronic voting system includes a precinct control unit and a plurality of voting stations networked to the precinct control unit, and the step of iterating is performed at a precinct control unit.

26. The method according to claim 25, including steps of accessing a memory storage device to obtain the ballot information and processing the ballot information to implement the ordering schema among the plurality of voting stations.

27. The method according to claim 26, wherein the step of iterating includes a step of balancing the selected order of ballot options amongst the plurality of voting stations so as not to favor any one of the plurality of ballot options at a precinct level during the course of an election.

28. The method according to claim 24, wherein the ballot information includes a plurality of contests each identified to corresponding ballot options and the step of iterating includes changing the selected order of corresponding ballot options among the plurality of contests.

29. The method according to claim 24 wherein the ballot information includes a plurality of contests each identified to corresponding ballot options and the step of iterating includes changing the selected order of corresponding ballot options among selected ones of the plurality of contests.

30. The method according to claim 29 wherein the electronic voting system includes a plurality of predetermined ordering schema for use in the iterating step and the method comprises a step of identifying one of the plurality of predetermined ordering schema for use in each contest.

31. The method according to claim 24, wherein the step of presenting includes presenting through use of an electronically configurable a visual display.

32. The method according to claim 24, wherein the step of presenting includes presenting through use of an audio speaker.

33. The method according to claim 24, wherein the step of presenting includes presenting through use of a Braille printer.

34. The method according to claim 24, wherein the step of permitting includes accepting input from a voter-directed ballot navigation tool.

35. The method according to claim 24, wherein the step of iterating comprises randomizing the selected order of ballot options between successive iterations.

36. The method according to claim 24, wherein the step of iterating comprises sequentially rotating the ballot options.

37. The method according to claim 36, wherein the step of sequentially rotating comprises uprotating adjacent ballot options.

38. The method according to claim 36, wherein the step of sequentially rotating comprises downrotating adjacent ballot options.

39. The method according to claim 24, wherein the step of iterating comprises implementing a comprehensive plan for ballot rotation at a precinct level.

40. The method according to claim 24, wherein the step of iterating comprises implementing a comprehensive plan for ballot rotation at an election jurisdiction level.

41. The method according to claim 24, wherein the step of iterating comprises implementing a system of ballot rotation that provides a number of rotation instances for each candidate at the top of the selected order such that predominance of any one candidate at the top of the selected order is statistically insignificant in influencing an election outcome.

42. The method according to claim 24, wherein the step of iterating comprises implementing a system of ballot rotation that provides, as close as is mathematically possible, an equal number of rotation instances for each candidate at all positions of the selected order.

43. In an electronic voting system that is used to present ballot information to voters during the course of an election where the ballot information includes a plurality of ordered ballot options for a contest, the improvement comprising:
a ballot rotation engine that is operable to change the order of ballot options according to a predetermined ordering schema for different voting sessions.
